(19) United States
(12) Patent Application Publication
(10) Pub. No.: US 2009/0303378 A1
(43) Pub. Date: Dec. 10, 2009

(54) Image pickup apparatus and method of controlling the same

(75) Inventors: Keijiro Yoshimatsu, Hyogo (JP); Shinichi Maehama, Osaka (JP); Yoshiaki Nishide, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/455,234

(22) Filed: May 29, 2009

(30) Foreign Application Priority Data
Jun. 5, 2008 (JP) P2008-147668

(51) Int. Cl. H04N 5/232

(52) U.S. Cl. 348/348; 348/E05.045

(57) ABSTRACT

An image pickup apparatus includes: a sub image sensor for obtaining a shot image with respect to a subject image; a subject detecting section for detecting a face region relevant to a subject; a shooting distance calculating section for calculating a shooting distance to the subject; a phase difference AF module for obtaining focus information according to a focusing condition obtained by use of a focusing lens; a phase difference AF control section which, when it is difficult to obtain the focus information, effects a determining operation for moving the focusing lens and determining a lens position at which the focus information can be obtained; and a control information obtaining section deciding the moving direction for the focusing lens in the determining operation, based on the shooting distance.

### BACKGROUND OF THE INVENTION

1. Field of the Invention

The present invention relates to a technology for automatic focusing (hereinafter referred to also as “autofocus” or “AF”) in image pickup apparatuses.

2. Description of the Related Art

In single lens reflex type digital cameras (hereinafter referred to also as “single lens reflex cameras”), in general, an AF technique of the phase difference detection system (hereinafter referred to also as “phase difference AF”) is adopted as an AF technique.

For example, in the single lens reflex camera described in Japanese Patent Laid-open No. 2007-322985, part of subject light having passed through a photographic optical system is guided by way of mirrors to a phase difference AF module (hereinafter referred also to simply as “AF module”). Then, two images are generated by a separator lens in the AF module, the interval between the two images is measured by a line sensor to obtain focus information, and the focal shift amount is calculated by use of the focus information.

In such phase difference AF, in the case of shooting a low-luminance subject or a low-contrast subject, it is difficult to compare the two images, and it may be impossible to obtain the focus information.

In such an instance, an operation of moving a focus lens at a low velocity to such a lens position as to enable the focus information to be obtained, while performing the image comparing operation (referred to also as “scanning operation”), is carried out (this operation will hereinafter be referred to as “low-contrast scanning operation”).

### SUMMARY OF THE INVENTION

In the low-contrast scanning operation, however, the focus lens is gradually moved at a low velocity in the range in which the focus lens can be driven, so that it may take a long time to determine the lens position at which the focus information can be obtained.

Thus, there is a need for a technology by which it is possible to shorten the time required for determining the lens position where the focus information can be obtained, in the above-mentioned low-contrast scanning operation.

According to an embodiment of the present invention, there is provided an image pickup apparatus including: an image sensor operative to obtain a shot image related to a subject image; means for detecting a face region of a subject from the shot image; means for calculating information on distance to the subject according to a size of the face region; means for obtaining focus information according to a focusing condition obtained by use of a focusing lens; operation control means for effecting a determining operation when it is difficult to obtain the focus information by the obtaining means, the determining operation being to move the focusing lens and to determine a lens position at which the focus information can be obtained; and means for deciding a moving direction for the focusing lens in the determining operation, based on the distance information.

According to another embodiment of the present invention, there is provided a method of controlling an image pickup apparatus, including the steps of: (a) obtaining a shot image related to a subject image; (b) detecting a face region of a subject from the shot image; (c) calculating information on the distance to the subject according to a size of the face region; (d) obtaining focus information according to a focusing condition obtained by use of a focusing lens; (e) effecting a determining operation when it is difficult to obtain the focus information in the step (d), the determining operation being to move the focusing lens and to determine a lens position at which the focus information can be obtained; and (f) deciding a moving direction for the focusing lens in the determining operation, based on the distance information.

According to the embodiments of the present invention, it is possible, in the determining operation to determine the lens position at which focus information can be obtained, to shorten the time required for determining the lens position at which the focus information can be obtained.

### BRIEF DESCRIPTION OF THE DRAWINGS

FIG. 1 illustrates an appearance-basis configuration of an image pickup apparatus according to a first embodiment of the present invention;

FIG. 2 illustrates another appearance-basis configuration of the image pickup apparatus according to the first embodiment of the invention;

FIG. 3 is a vertical sectional view of the image pickup apparatus according to the first embodiment;

FIG. 4 is a vertical sectional view of the image pickup apparatus according to the first embodiment;

FIG. 5 is a block diagram showing a functional configuration of the image pickup apparatus according to the first embodiment;

FIG. 6 is a vertical sectional view of the image pickup apparatus in an EVF (electronic viewfinder) mode;

FIG. 7 is a flow chart for a shooting operation of the image pickup apparatus;

FIG. 8 is a flow chart for phase difference AF;

FIG. 9 illustrates, on a two-dimensional basis, the relationship between a face in a subject field and a face region imaged on an image pickup plane of a sub image sensor;

FIG. 10 illustrates a manner of driving a focus lens;

FIG. 11 illustrates a manner of driving the focus lens;

FIG. 12 is a flow chart for phase difference AF in an image pickup apparatus according to a second embodiment of the present invention;

FIG. 13 illustrates a manner of driving the focus lens;

FIG. 14 illustrates a manner of driving the focus lens;

FIG. 15 illustrates a manner of driving the focus lens;

FIG. 16 illustrates a manner of driving the focus lens;

FIG. 17 illustrates a manner of driving the focus lens; and

FIG. 18 illustrates a manner of driving the focus lens.

### DETAILED DESCRIPTION OF THE PREFERRED EMBODIMENTS

Now, some embodiments of the present invention will be described below referring to the drawings.

### 1. First Embodiment

### <Configuration>

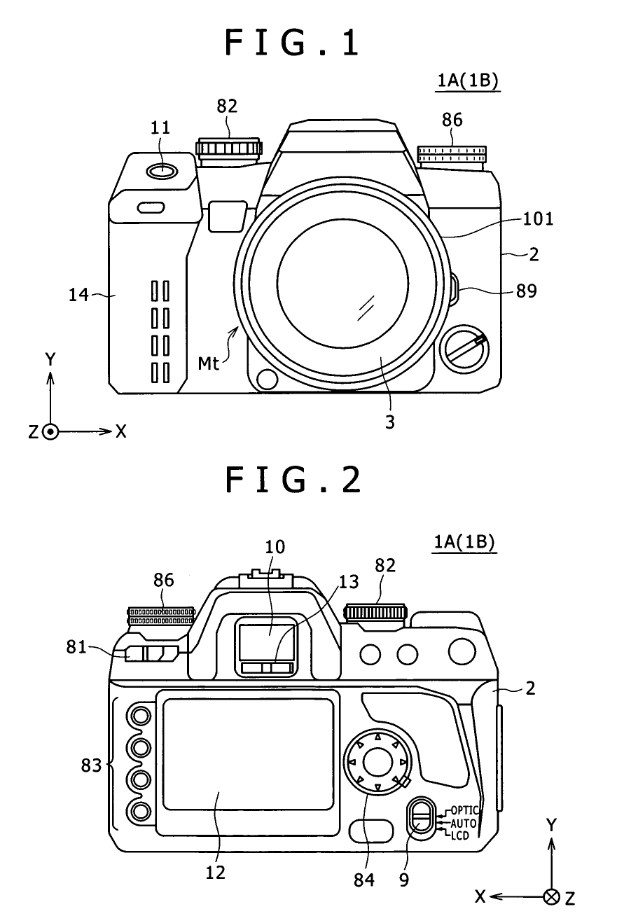

FIGS. 1 and 2 illustrate appearance-basis configurations of an image pickup apparatus 1A according to a first embodiment of the present invention, wherein FIG. 1 shows front appearance of the image pickup apparatus 1A, and FIG. 2 shows back appearance of the image pickup apparatus 1A. The image pickup apparatus 1A is configured as a lens interchange system single lens reflex type digital camera.

As shown in FIG. 1, the image pickup apparatus 1A has an image pickup apparatus body (camera body) 2. An interchangeable photographic lens unit (referred also to simply as “photographic lens” or “interchangeable lens”) 3 is attachable to and detachable from the camera body 2.

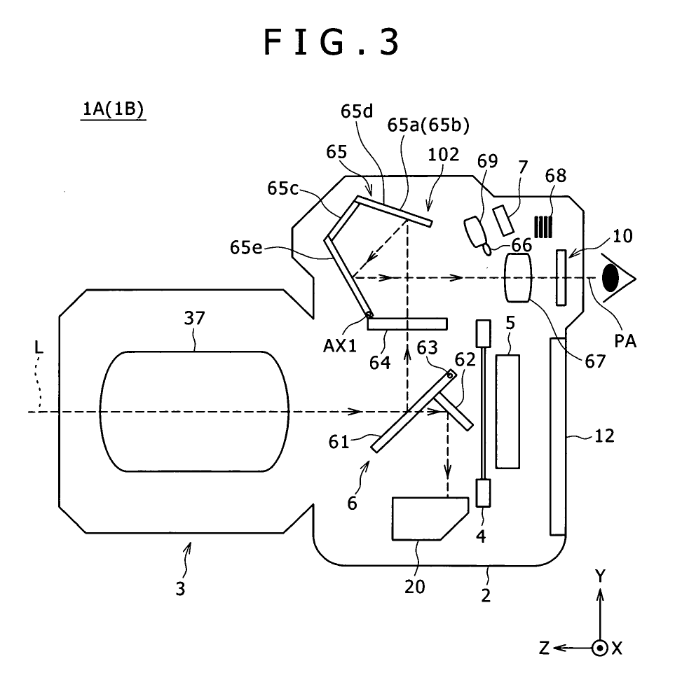

The photographic lens 3 is composed mainly of a lens barrel 101, and a lens group 37 (see FIG. 3) and a diaphragm (not shown), etc. provided inside the lens barrel 101. The lens group 37 includes a focus lens for changing the focal point position by being moved in the optical axis direction (this lens is referred to also as “focusing lens” or “AF lens”), etc.

The camera body 2 is provided at a substantially central portion of a front surface thereof with an annular mount part Mt on which the photographic lens 3 is mounted, and is provided near the mount part Mt with an attach/detach button 89 for attaching and detaching the photographic lens 3.

In addition, the camera body 2 is provided with a mode setting dial 82 at a left upper portion of the front surface thereof, and with a control value setting dial 86 at a right upper portion of the front surface thereof. By operating the mode setting dial 82, it is possible to perform setting operations (changeover operations) for setting various camera modes (inclusive of various shooting modes (a portrait mode, a landscape mode, a successive shot mode, etc.), a reproduction mode for reproducing shot images, and a communication mode for data communication with external apparatuses). Besides, by operating the control value setting dial 86, it is possible to set control values in the various shooting modes.

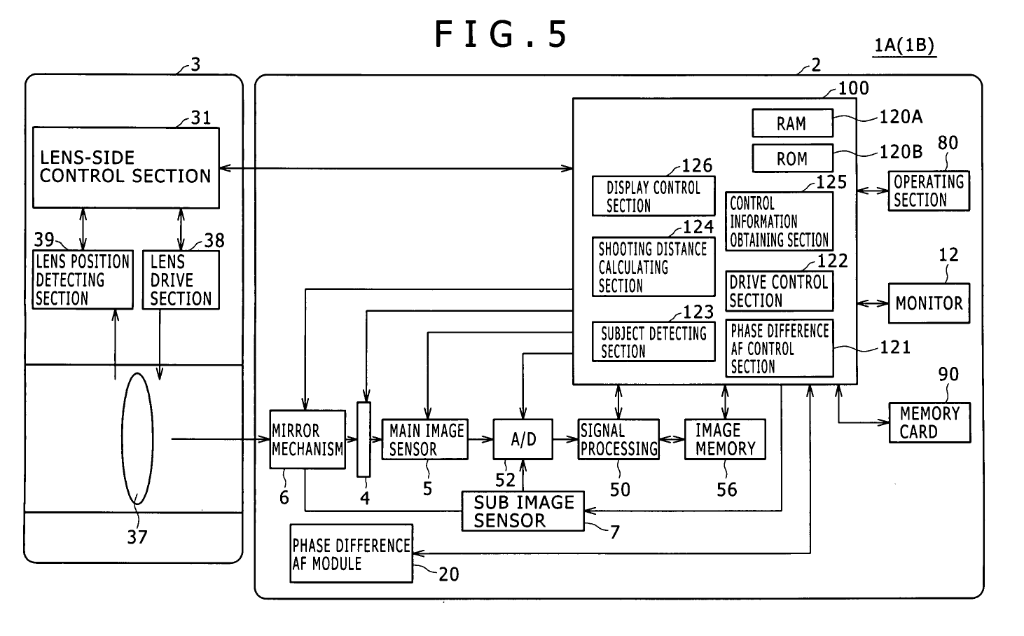

Further, the camera body 2 is provided at a left end portion of the front surface thereof with a grip part 14 to be gripped by the user. At a top surface of the grip part 14, a release button (shutter button) 11 for instructing the start of exposure is provided. A battery compartment and a card compartment are provided inside the grip part 14. For example, four size AA dry batteries can be stored in the battery compartment as a power supply for the camera, and a recording medium (here, a memory card 90 (see FIG. 5)) for recording image data of shot images can be detachably stored in the card compartment.

The release button 11 is a two-stage detection type button which enables detection of two conditions, i.e., a half-pressed condition (S1 condition) and a full-pressed condition (S2 condition). When the release button 11 is half pressed into the S1 condition, a preparatory operation (for example, an AF control operation, an AE (auto exposure) control operation, or the like) for obtaining a recording still image (real shot image) relevant to a subject is conducted. When the release button 11 is pressed further into the S2 condition, a shooting operation for the real shot image (a series of real shooting operations for performing an exposure operation as to a subject image by use of an image sensor (referred to also as “main image sensor”) 5 (described later) and subjecting the picture signal obtained by the exposure operation to a predetermined image processing) is carried out.

In FIG. 2, a monitor 12 as a display section is provided at a substantially central portion of the back surface of the camera body 2. The monitor 12 is configured as a color liquid crystal display (LCD), for example. Operations which can be performed by use of the monitor 12 include an operation of displaying a menu screen for setting of shooting conditions, etc., and an operation of reproducing and displaying a shot image or images recorded in the memory card 90 in the reproduction mode.

A finder window 10 is provided at a substantially central upper portion of the back surface of the camera body 2. A subject image coming from the photographic lens 3 is guided to the finder window 10, so that by peeping into the finder window 10 the user can visually confirm an image equivalent to the subject image to be obtained by the main image sensor 5. Specifically, the subject image incident on the photographic optical system is reflected to the upper side by a mirror mechanism 6 (see FIG. 3), to be visually confirmed through an eyepiece 67. Thus, by peeping into the finder window 10, the user can decide a composition (perform framing). Incidentally, when the real shooting operation is started in response to the detection of the S2 condition of the release button 11, the mirror mechanism 6 is retracted from the optical path of the light (subject light) forming the subject image, so that the light from the photographic lens 3 (the light forming the subject image) reaches the main image sensor 5, whereby the shot image (image data) pertaining to the subject is obtained.

A peeping eye detecting sensor 13 is provided at a lower portion of the finder window 10. The peeping eye detecting sensor 13 is a sensor for detecting the presence or absence of a proximate object, and detects the presence or absence of the use of the optical finder by the user.

A main switch 81 is provided on the left upper side of the monitor 12. The main switch 81 is configured as a two-point slide switch. With the contact of the main switch 81 set to an “OFF” position at the left, the power source for the image pickup apparatus 1A is turned off. With contact set to an “ON” position at the right, the power source for the image pickup apparatus 1A is turned on.

A direction selecting key 84 and a display changeover switch 9 are provided on the right side of the monitor 12. The direction selecting key 84 has a circular operating button, of which pressing in any of four directions of upward, downward, leftward and rightward directions and pressing in any of four directions of rightwardly upward, leftwardly upward, rightwardly downward and leftwardly downward directions are detected individually. Incidentally, separately from the pressing of the direction selecting key 84 in any of the eight directions, pressing of a pushbutton at a central portion of the direction selecting key 84 is also detected.

The display changeover switch 9 is configured as a three-point slide switch. With the contact of the display changeover switch 9 set to an “optic” position at the upper level, an optical viewfinder mode (referred to also as “OVD mode”) is selected, and a subject image is displayed in the visual field of the optical finder. This enables the user to visually confirm the subject image in the optical finder visual field through the finder window 10 and thereby to perform a composing operation (referred to also as “framing”).

In addition, with the contact of the display changeover switch 9 set to an “LCD” position at the lower level, an electronic viewfinder mode (referred to also as “EVF” mode) is selected, and a live view image pertaining to the subject image is displayed on the monitor 12 in the manner of a motion picture (live view display). This enables the user to visually confirm the live view image displayed on the monitor 12 and thereby to carry out framing.

Further, with the contact of the display changeover switch 9 set to an “auto” position at the middle level, switching between the display in the optical finder visual field (referred to also as “OVF display”) and the live view display is automatically performed according to the presence of absence of the dye peeping into the finder window 10. This enables the user to perform framing while visually confirming either the display in the optical finder visual field or the live view display, according to the manner in which the image pickup apparatus 1A is used.

A setting button group 83 composed of a plurality of buttons for performing settings on the menu screen, deletion of an image, etc. is provided on the left side of the monitor 12.

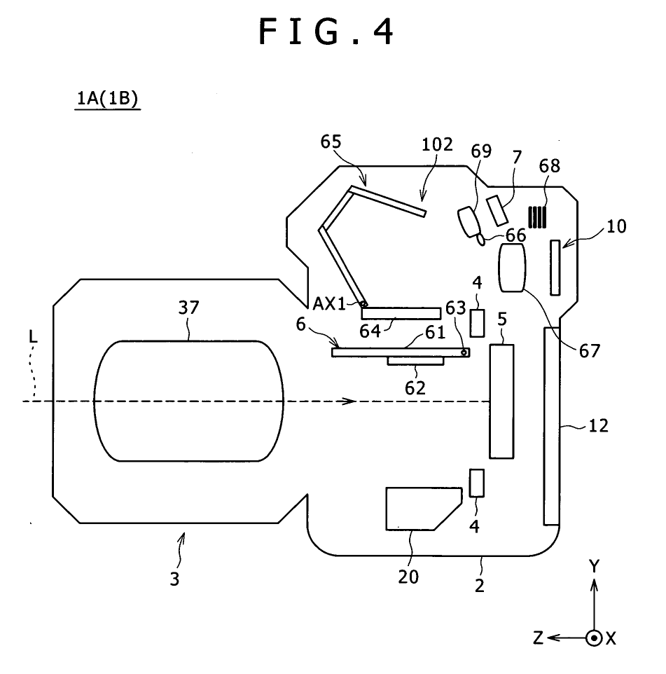

Now, the internal configuration of the image pickup apparatus 1A will be described below. FIGS. 3 and 4 are vertical sectional views of the image pickup apparatus 1A according to the first embodiment of the present invention.

As shown in FIG. 3, the image pickup apparatus 1A is provided therein with a finder section (referred to also as “finder optical system”) 102, the mirror mechanism 6, a phase difference AF module (hereinafter referred also to simply as “AF module”) 20, a shutter 4, the main image sensor 5, a sub image sensor 7 and the like.

The main image sensor (here, a CCD sensor (referred also to simply as “CCD”)) 5 is disposed on an optical axis L of the lens group 37 possessed by the photographic lens 3, specifically, in a plane orthogonal to the optical axis L. The main image sensor 5 converts a subject image, formed of the light received in an image pickup plane, into an electrical signal by its photoelectric conversion action, to generate a picture signal relevant to a real shot image.

The shutter 4 is disposed just in front of the main image sensor 5. The shutter 4 is a mechanical focal plane shutter which has a diaphragm moved in the vertical direction, and performs an optical path opening operation and an optical path shut-off operation for the subject light guided along the optical path L to the main image sensor 5.

In addition, as shown in FIG. 3, the mirror mechanism 6 is provided on the optical path (referred to also as “photographic optical path”) which extends from the photographic lens 3 to the main image sensor 5.

The mirror mechanism 6 has a main mirror 61 (main reflective surface) by which the light from the photographic optical system is reflected upwards. The main mirror 61 is configured, for example, partly or entirely as a half mirror, through which part of the light from the photographic optical system is transmitted. Besides, the mirror mechanism 6 also has a sub mirror 62 (sub reflective surface) by which the light transmitted through the main mirror 61 is reflected downwards.

In addition, the mirror mechanism 6 is configured as a so-called quick return mirror, the posture of which can be switched between a mirror-down state and a mirror-up state.

Specifically, the mirror mechanism 6 is so arranged that it is in the mirror-down state until the release button 11 is full-pressed into the S2 condition in the shooting mode, in other words, during framing (see FIG. 3). In the mirror-down state, the subject light from the photographic lens 3 is reflected upwards by the main mirror 61, to be incident on the finder section (referred to also as “finder optical system”) 102 as a luminous flux for observation.

Further, part of the subject light is transmitted through the main mirror 61, and is reflected downwards by the sub mirror 62, to be guided to the AF module 20.

The AF module 20 has a separator lens, a line sensor (focus detecting sensor) and the like, and functions as a so-called AF sensor by which information on focusing (referred to also as “focusing information,” “focus information,” or “range-finding information”) according to the focusing condition obtained by use of the focus lens.

Specifically, the AF module 20 functions so that the light from a subject in a range-finding area (referred to also as “focus area” or “AF area”) set in a shooting area is separated by the separator lens, to produce two images. The AF module 20 has a phase difference detecting function by which the two images are received by the line sensor and a phase difference detection signal according to the interval between the images is outputted as focus information. In other words, in the mirror-down state during stand-by for shooting, the focus information is outputted from the AF module 20, based on the subject light guided to the AF module 20.

In this manner, the AF module 20 functions as a focus information obtaining means for obtaining the focus information from the AF area set fixedly at a predetermined position in the shooting area.

On the other hand, with the release button 11 full-pressed into the S2 condition, the mirror mechanism 6 is so driven to come into the mirror-up state (see FIG. 4), and an exposure operation is started.

Specifically, as shown in FIG. 4, at the time of exposure, the mirror mechanism 6 springs up to the upper side, with a rotary shaft 63 as a fulcrum, to be retracted from the photographic optical path. More in detail, the main mirror 61 and the sub mirror 62 are retracted to the upper side so as not to shut off the light coming from the photographic optical system, so that the light from the photographic lens 3 reaches the main image sensor 5 synchronously with the opening timing of the shutter 4. The main image sensor 5, through photoelectric conversion, generates a picture signal relevant to the subject image, based on the luminous flux received thereby. Thus, the light from the subject is guided through the photographic lens 3 to the main image sensor 5, whereby the shot image (shot image data) pertaining to the subject is obtained.

### <Functional Blocks>

Now, an outline of the functions of the image pickup apparatus 1A will be described below. FIG. 5 is a block diagram showing the functional configuration of the image pickup apparatus 1A according to the first embodiment of the present invention.

As shown in FIG. 5, the image pickup apparatus 1A includes the phase difference AF module 20, an operating section 80, a general control unit 100, the mirror mechanism 6, the shutter 4, the main image sensor 5, an A/D conversion circuit 52, a digital signal processing circuit 50, and an image memory 56.

The operating section 80 is configured to have various buttons, inclusive of the release button 11 (see FIG. 1), and switches, etc. In response to user's inputting operations performed on the operating section 80, the general control unit 100 realizes various operations.

In response to drive control signals (a storage start signal and a storage end signal) inputted from a timing control circuit (not shown), the main image sensor 5 performs exposure (storage of electric charges through photoelectric conversion) of the subject image formed in the light receiving surface (image pickup surface), to produce the picture signal relevant to the subject image.

The picture signal (analog signal) obtained at the main image sensor 5 is converted into a digital signal by the A/D conversion circuit 52. The picture signal converted into the digital signal is inputted to the digital signal processing circuit 50.

The digital signal processing circuit 50 applies digital signal processing to the picture signal inputted thereto from the A/D conversion circuit 52. Specifically, it performs signal processing such as black level correction processing, white balance (WB) processing, and y correction processing. The picture signal (image data) obtained upon the signal processing is stored in the image memory 56.

The image memory 56 is a high-speed accessible memory for temporarily storing the image data thus produced, and has such a capacity as to store an amount of image data corresponding to a plurality of frames.

At the time of real shooting, the image data temporarily stored in the image memory 56 is subjected to image processing (compression, or the like) in the general control unit 100, as required, before being stored into the memory card 90.

The sub image sensor 7 basically has the same function as the main image sensor 5, and plays the role as an image sensor (auxiliary image sensor) for obtaining so-called live view images (for a electronic finder). Specifically, the sub image sensor 7 performs exposure of the subject image guided to the finder optical system, to obtain a picture signal related to images for live view display. Incidentally, it suffices for the sub image sensor 7 to have a resolution for producing a live-view picture signal, and the number of pixels of the sub image sensor 7 is normally smaller than that of the main image sensor 5.

The image data obtained by the sub image sensor 7 undergoes predetermined processing in the A/D conversion circuit 52 and the digital signal processing circuit 50, is once stored in the image memory 56, and is thereafter displayed on the monitor 12.

The general control unit 100 is configured as a microcomputer, and mainly has a CPU (Central Processing Unit), a RAM (Random Access Memory) 120A, and a ROM (Read-Only Memory) 120B. The general control unit 100 reads a program stored in the ROM 120B, and executes the program by the CPU, so as to realize various functions.

By executing the above-mentioned program, the general control unit 100 realizes a phase difference AF control section 121, a drive control section 122, a subject detecting section 123, a shooting distance calculating section 124, a control information obtaining section 125, a display control section 126 and the like on a functional basis.

Incidentally, the functions realized respectively by the shooting distance calculating section 124 and the control information obtaining section 125 are used at the time of carrying out a low-contrast scanning operation (described later) in the EVF mode.

The phase difference AF control section 121 performs an autofocus (AF) operation (phase difference AF) by the phase difference detection system. Specifically, the phase difference AF control section 121 performs a lens focusing position determining operation for determining the position of the focus lens at the time of focusing (lens focusing position), based on the focus information outputted from the AF module 20.

In addition, the phase difference AF control section 121 functions as an operation control means for effecting the low-contrast scanning operation when it is difficult to obtain the focus information.

To be more specific, in the case where a low-luminance subject or a low-contrast subject is to be shot, the output from the line sensor concerning the two images is small, which makes it difficult to measure the interval between the two images by comparing the images. In the case where it is thus difficult to measure the image interval and it is very difficult to obtain the focus information, the AF module 20 outputs an impossibility signal indicating that it is difficult to obtain the focus information. Upon receiving the impossibility signal, the phase difference AF control section 121 effects an operation (low-contrast scanning operation) to perform the image comparing operation (scanning operation), while moving the focus lens at a low velocity, and to determine a lens position at which the focus information can be obtained.

The drive control section 122 effects a lens driving operation to move the focus lens in the optical axis direction according to a control signal from the phase difference AF control section 121.

Specifically, the drive control section 122 moves a lens-side control section 31 in the photographic lens 3 according to the control signal from the phase difference AF control section 121. The lens-side control section 31 drives a lens drive section 38 according to a command from the drive control section 122, whereby the focus lens included in the lens group 37 of the photographic lens 3 is moved in the optical axis direction. In addition, the position of the focus lens (referred also to simply as “lens position”) is detected by a lens position detecting section 39 of the photographic lens 3, and data indicative of the position of the focus lens is sent from the lens-side control section 31 to the general control unit 100 in the camera body 2.

In addition, in the low-contrast scanning operation, the drive control section 122 receives drive information from the control information obtaining section 125, and controls a driving operation for the focus lens at the time of the low-contrast scanning operation.

The subject detecting section 123 performs a subject detecting operation for detecting a specified subject from a shot image (auxiliary image) obtained by the sub image sensor 7. Here, a human face (referred to also as “face region”) is taken as the specified subject, and a face detecting operation to detect the face region from the auxiliary image is carried out.

As a technique for detecting the face region, for example, a technique may be adopted in which, based on pixel values of pixels in the auxiliary image, a flesh color portion of the image is extracted, and, when the area of the flesh color portion is not less than a preset threshold, a region including the flesh color portion is detected as the face region. Or, alternatively, a technique may be adopted in which a specified portion of a face such as an eye or a mouth is extracted by use of a known pattern recognition technology, thereby detecting the face region.

The face detecting operation is carried out by use of those auxiliary images at intervals of several frames of the auxiliary images successively obtained by the sub image sensor 7. When the face region is detected, the face position is displayed in the live view image. Besides, the face region detected from the auxiliary image is used for an AF operation.

The shooting distance calculating section 124 functions in the low-contrast scanning operation, to obtain information (distance information) on the distance from the image pickup apparatus 1A to a subject (referred to also as “shooting distance”), based on the size of the face region detected.

The control information obtaining section 125 functions in the low-contrast scanning operation, to obtain information on the driving of the focus lens (referred to also as “drive control information” or “drive information”), based on the distance information.

Here, based on the distance information, a lens position at which a focused condition can be obtained (lens focusing position) is estimated, to obtain an estimated lens position (referred to also as “estimated focusing position”). Then, based on the estimated lens position and the current position of the focus lens FL (referred to also as “current lens position”), a moving direction (driving direction) for the focus lens FL is decided. Thus, in this embodiment, the control information obtaining section 125 functions as a driving direction deciding means for the focus lens FL, and the driving direction decided is transmitted to the drive control section 122 as drive information.

The display control section 126 controls the contents displayed on a display unit such as the monitor 12. For example, the display control section 126 allows successive images to be displayed on the monitor 12, based on the shot images obtained successively by the sub image sensor 7.

### <About Composing Operation (Framing Operation)>

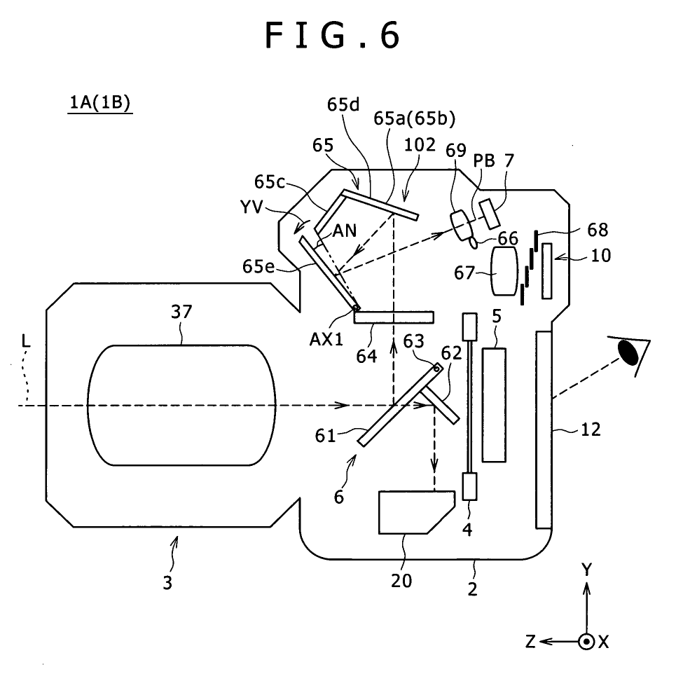

Now, the composing operation in the image pickup apparatus 1A will be described below. As above-mentioned, in the image pickup apparatus 1A, the user can choose by sliding the display changeover switch 9 between composing by utilizing the optical finder in the OVF mode and composing by utilizing the electronic finder in the EVF mode. FIG. 6 is a vertical sectional view of the image pickup apparatus 1A in the EVF mode.

At the time of composing, the mirror mechanism 6 is disposed in the mirror-down state (see FIGS. 3 and 6). As has been above-mentioned, in the mirror-down state, the subject image coming from the photographic lens 3 is reflected upwards by the main mirror 61, to be guided to the finder section 102 as a luminous flux for observation.

The finder section 102 includes a penta mirror 65, the eyepiece 67, an eyepiece shutter 68, the finder window 10, a photometric element 66, an image forming lens 69, and the sub image sensor 7.

The penta mirror 65 has a plurality of mirrors (reflective surfaces), and has a function of reversing the top and bottom sides as well as the left and right sides of the subject image by reflection so as to obtain an erect image and a function of changing the optical path of the subject light.

Specifically, the penta mirror 65 has two surfaces of mirrors (roof mirrors) 65a, 65b formed in a triangular roof-like shape, a surface 65c fixed to the roof mirrors (roof surfaces) 65a, 65b, and an optical path changing mirror (reflective surface) 65e.

The roof mirrors 65a, 65b are formed as an integral component part 65d by plastic molding, and have the function of reversing the posture of the subject image by reflecting the subject light twice. The optical path changing mirror 65e has the function of changing the optical path of the subject light according to which one of the optical finder and the electronic finder is adopted to decide a composition.

The eyepiece 67 has the function of guiding the subject image, having been turned into an erect image by the penta mirror 65 and the like, to the outside of the finder window 10.

The eyepiece shutter 68 is provided between the eyepiece 67 and the finder window 10, and functions as a light shut-off (shutter) means capable of being switched between a shutting-off state for shutting off the external light which might otherwise enter via the finder window 10 into the image pickup apparatus 1A and a non-shutting-off state for not shutting off the external light coming from the finder window 10. For instance, the eyepiece shutter 68 comes into the shutting-off state in the EVF mode, and comes into the non-shutting-off state in the OVF mode.

The photometric element 66 receives part of the observation luminous flux entering the finder section 102, and generates (outputs) a photometric signal (photometric value) with respect to the brightness of the subject, or the luminance of the subject (referred to also as “subject luminance”).

In the photometric element 66, a light receiving part is divided into a plurality of areas (referred to also as “photometric regions” or “photometric areas”), and photometric measured values are individually obtained for each of the photometric areas.

Now, each of the framing operation conducted using the optical finder and the framing operation conducted using the electronic finder will be described in detail.

First, the framing operation conducted using the optical finder will be described.

As shown in FIG. 3, in the OVF mode, the mirror mechanism 6 is disposed on the optical path of the subject image coming from the photographic lens 3, and the subject image is guided sequentially through the main mirror 61 and the penta mirror 65 and the eyepiece 67 to the finder window 10.

More specifically, the subject light having passed through the photographic lens 3 is reflected upwards by the main mirror 61, to form an image on a focal plane plate 64. The subject light having formed the image on the focal plane plate 64 passes through the focal plane plate 64, and, after the changing of its course by the penta mirror 65, passes through the eyepiece 67 toward the finder window 10 (see an optical path PA in FIG. 3). The subject image thus guided along the optical path PA to the finder window 10 reaches to the eye of the user (observer), to be visually confirmed.

Thus, in the OVF mode, by peeping into the finder window 10 the user can visually confirm the subject image displayed in the visual field of the finder and can thereby decide a composition.

Now, the framing operation conducted using the electronic finder will be described below.

As shown in FIG. 6, in the EVF mode, the mirror mechanism 6 is disposed on the optical path of the subject image coming from the photographic lens 3. The subject light having passed through the photographic lens 3 is reflected upwards by the main mirror 61, to form an image on the focal plane plate 64. The subject light having thus formed the image on the focal plane plate 64 passes through the focal plane plate 64, and, after the changing of its course by the penta mirror 65, passes through the image forming lens 69 (image forming optical system), to again form an image on an image pickup plane of the sub image sensor 7 (see an optical path PB in FIG. 6).

Thus, in the EVF mode, the subject image is guided to the sub image sensor 7 along the optical path PB different from the optical path PA in the OVF mode.

Such a change of the optical path in the finder section 102 is realized by modifying the angle of the optical path changing mirror 65e (its arrangement angle relative to the camera body 2) according to the finder mode.

Specifically, the optical path changing mirror 65e is configured to be rotatable about an axis AX1 in conjunction with the sliding operation of the display changeover switch 9. In the EVF mode (see FIG. 6), the optical path changing mirror 65e is turned by a predetermined angle AN in the direction of arrow YV around the axis AX1, as compared with its posture in the OVF mode (see FIG. 3).

Thus, in the EVF mode, the optical path of the subject light in the finder section 102 is changed by modifying the posture of the optical path changing mirror 65e. This results in that the subject light passes through the image forming lens 69, to reach the sub image sensor 7.

As has been above-mentioned, the sub image sensor 7 receives the subject light reaching it along the optical path PB, and successively obtains shot images relevant to the subject image at very short time intervals (for example, 1/60 sec). The shot images thus obtained in time series are sequentially displayed on the monitor 12 in the manner of a motion picture (live view display).

This enables the user to decide a composition while visually confirming the motion-picture images (live view images) displayed on the monitor 12.

Incidentally, the image forming lens 69, the sub image sensor 7 and the photometric element 66 are arranged in such positions as not to shut off the luminous flux advancing from the optical path changing mirror 65e to the eyepiece 67 in the OVF mode (here, in positions on the upper side of the eyepiece 67).

Thus, in the image pickup apparatus 1A, the optical path of the subject light is changed by modifying the posture of the optical path changing mirror 65e in the finder section 102, whereby switching between the OVF mode and the EVF mode can be achieved.

### <Shooting Operation>

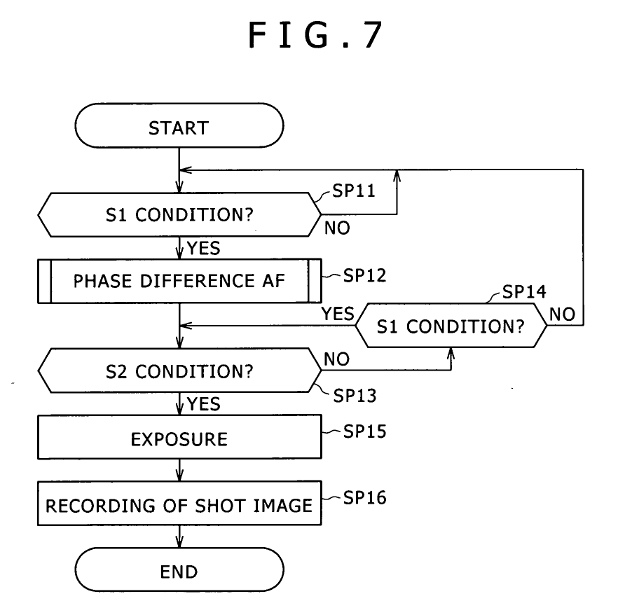

Now, the shooting operation of the image pickup apparatus 1A will be described below. FIG. 7 is a flow chart for a shooting operation of the image pickup apparatus 1A.

As shown in FIG. 7, in step SP11 decision on the start of AF is made based on the pressed state of the release button 11. Specifically, when a half-pressed condition (S1 condition) of the release button 11 is detected, the control proceeds to step SP12; on the other hand, when the half-pressed condition (S1 condition) is not detected, a wait state is kept until the half-pressed condition is detected.

In step SP12, focusing by phase difference AF is conducted based on focus information obtained by the AF module 20. The details of it will be described later.

In the subsequent step SP13, decision on the start of shooting is made based on the pressed state of the release button 11. Specifically, the control goes to step SP14 if a full-pressed condition (S2 condition) of the release button 11 is not detected.

In step SP14, it is determined whether or not the half-pressed condition of the release button 11 is being continued. When it is determined that the half-pressed condition is being continued, the control goes to step SP13, and the processing of step SP13 and the processing of step SP14 are executed repeatedly until the full-pressed condition is detected. On the other hand, when it is determined that the half-pressed condition has been released, the control goes back to step SP11.

Besides, when the full-pressed condition (SP2 condition) of the release button 11 is detected in step SP13, the control process proceeds to step SP15.

In step SP15, an exposure operation is performed. Specifically, a mirror-up state is established in which a subject image is entirely guided to the main image sensor 5, and exposure by the main image sensor 5 is started.

In step SP16, a real shot image obtained by the main image sensor 5 is recorded into the memory card 90.

Thus, in the image pickup apparatus 1A, the shot image is obtained by the exposure after the focusing by the phase difference AF is carried out.

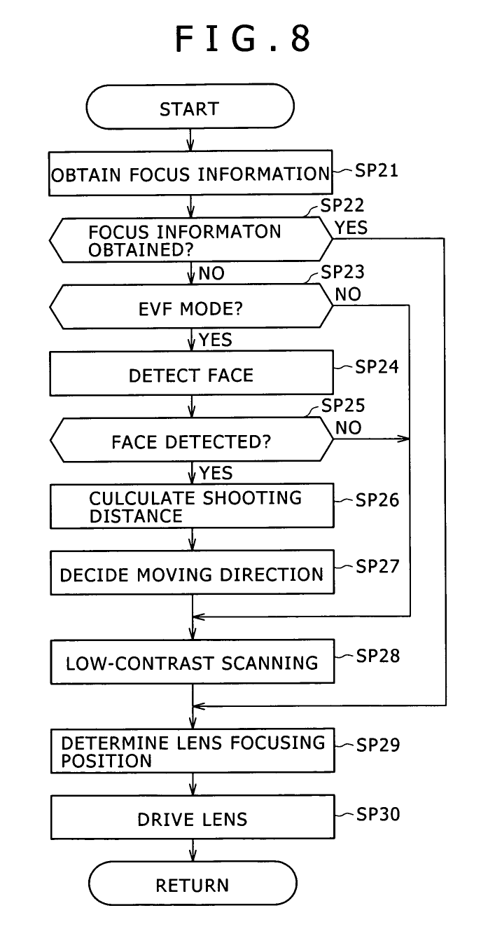

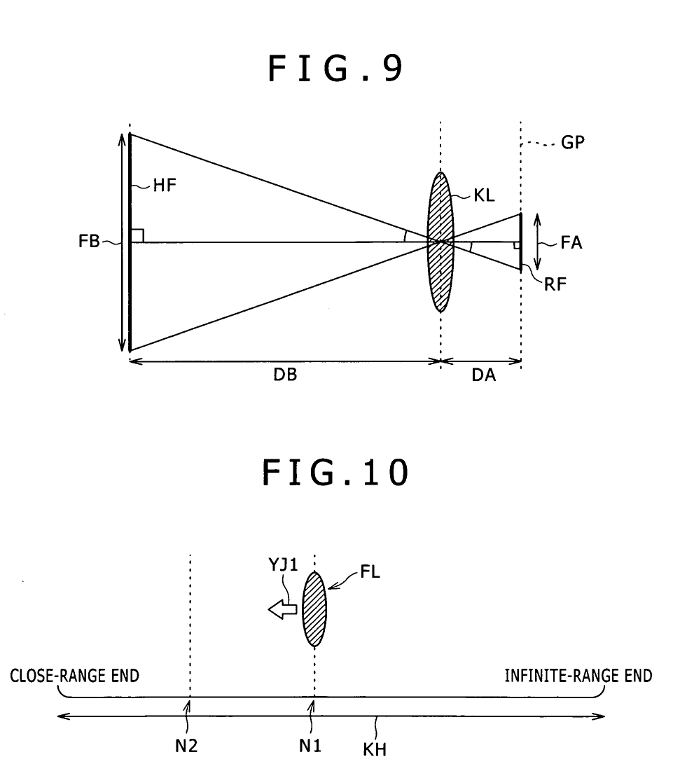

Here, the phase difference AF carried out in step SP12 will be described in detail. FIG. 8 is a flow chart for the phase difference AF. FIG. 9 illustrates, on a two-dimensional basis, the relationship between a face HF in the subject field and a face region RF imaged on the image pickup plane GP of the sub image sensor 7.

When the half-pressed condition of the release button 11 is detected (step SP11), the phase difference AF composed of the steps shown in FIG. 8 is started.

Specifically, in step SP21, focus information is obtained in the AF module 20, and is outputted to the general control unit 100.

In step SP22, it is judged in the phase difference AF control section 121 whether or not the focus information has been obtained by the AF module 20.

When it is judged that the focus information has been obtained by the AF module 20, the control process jumps to step SP29, in which a normal lens focusing position determining operation by use of the focus information is carried out. On the other hand, in the case where the focus information has not been obtained by the AF module 20 and an impossibility signal is outputted from the AF module 20, the control proceeds to step SP23.

In step SP23, it is judged whether or not the EVF mode has been selected. If the EVF mode has not been selected (when the OVF mode has been selected), the control process jumps to step SP28, in which a normal low-contrast scanning operation (described later) is carried out. On the other hand, where the EVF mode has been selected, the control proceeds to step SP24.

In step SP24, a face detecting operation is performed by the subject detecting section 123, whereby the face region RF is detected from the auxiliary image.

In step SP25, it is determined whether or not the face region RF has been detected from the auxiliary image. If the face region RF has not been detected, the control goes to step SP28, in which the normal low-contrast scanning operation is carried out. On the other hand, where the face region has been detected, the control proceeds to step SP26.

In step SP26, the shooting distance is calculated in the shooting distance calculating section 124. The calculation of the shooting distance is carried out by use of the size of the face region RF in the auxiliary image, which is determined based on the result of face detection, the actual size of a human face HF, and the focal distance.

Specifically, assuming an equivalent lens KL obtained through composition of the lenses included in the lens group 37 and the image forming lens 69, the relationship between the face HF in the subject field and the face region RF imaged on the image pickup plane GP of the sub image sensor 7 is as illustrated in FIG. 9. Here, the size “FB” of the face HF in the subject field and the focal distance “DA” are known. Therefore, if the size “FA” of the face region RF can be determined based on the result of face detection, the shooting distance “DB” can be calculated by utilizing the relation of similarity.

To be more specific, the shooting distance “DB” can be expressed as the following formula (1) using the focal distance “DA,” the size “FA” of the face region RF in the auxiliary image, and the size “FB” of the face HF in the subject field.

DB=(FB×DA)/FA (1)

Incidentally, the size “FB” of the face HF in the subject field may be changed according to whether the subject person is an adult or a child, and an ordinary face size of an adult or child is set. For example, the size of the face HF of an adult is set to “20 cm,” while the size of the face HF of a child is set to “15 cm.” Incidentally, the judgment as to whether the subject person is an adult or a child may be made, for example, by a user's operation conducted using the menu screen (menu operation) or the like.

In addition, the size “FA” of the face region RF in the auxiliary image is calculated by use of the pixels contained in the face region detected. For example, a method may be adopted in which the number of the pixels present in series in the face region RF along the vertical direction (or horizontal direction) of the auxiliary image is calculated on a pixel column basis (or on a pixel row basis), and the length of the pixel column (pixel row) containing the largest number of pixels is taken as the size “FA” of the face region RF.

The shooting distance calculated in this manner is accurately the distance from the equivalent lens KL to the main subject in the subject field. Since the equivalent lens KL is provided in the image pickup apparatus 1A, however, the shooting distance thus obtained can also be expressed as the distance from the image pickup apparatus 1A to the main subject.

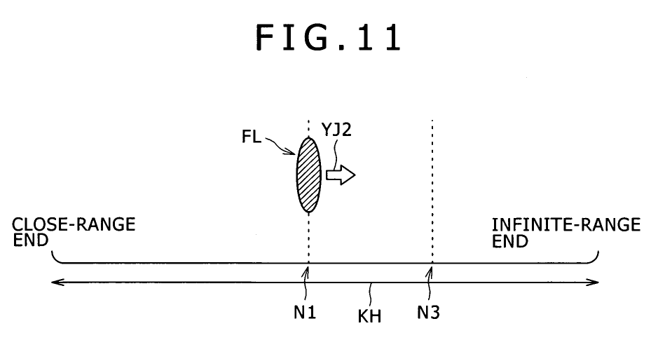

In the next step SP27, the moving direction for the focus lens FL is decided in the control information obtaining section 125, based on the current position of the focus lens FL (current lens position) and the shooting distance. Specifically, the focus lens FL is driven in the manner as described below referring to FIGS. 10 and 11.

As illustrated in FIGS. 10 and 11, for the focus lens FL, there exists a range KH in which it can be driven along the optical axis direction in a focusing operation (referred to also as “drivable range”).

The lens position at which to realize the focused condition in the drivable range KH (referred to also as “lens focusing position”) corresponds to the distance from the lens group 37 of the photographic optical system to the subject. Therefore, the lens focusing position in the drivable range KH can be estimated by use of the distance from the lens group 37 to the subject. Incidentally, herein, the lens position in the drivable range KH at which the focused condition can be realized with respect to a subject in a closest-range view is referred to as “close-range end.” On the other hand, the lens position at which the focused condition can be realized for a subject in the farthest-range view (infinite-distant view) is referred to as “infinite-range end” or “telephoto end.”

For example, it is assumed that the current lens position “N1” of the focus lens FL has been detected by the lens position detecting section 39, as shown in FIG. 10. In this case, if the estimated lens position estimated from the shooting distance calculated in step SP26 is present at a position “N2” on the close-range end side in relation to the current lens position “N1,” the focus lens FL is driven toward the close-range end side as indicated by arrow YJ1. On the other hand, if the estimated lens position is present at a position “N3” on the infinite-range end side in relation to the current lens position “N1,” the focus lens FL is driven toward the infinite-range end side as indicated by arrow YJ2.

Thus, the driving direction in which to move the focus lens FL is decided according to the positional relationship between the estimated lens position and the current lens position, and the focus lens FL is driven toward the estimated lens position.

Returning to FIG. 8, in the subsequent step SP28, the low-contrast scanning operation is started. In the low-contrast scanning operation, the focus lens FL is moved stepwise in the drivable range KH, while the scanning operation is carried out at each lens position.

In the case where the low-contrast scanning operation is carried out following to step SP27, in other words, where the driving direction for the focus lens FL has been decided, the scanning operation is started in the driving direction decided.

On the other hand, in the case where the low-contrast scanning operation is conducted without being preceded by step SP27, namely, where the driving direction for the focus lens FL has not been decided, a normal low-contrast scanning operation is carried out. For instance, the focus lens FL is driven toward one of the close-range end and the infinite-range end that is nearer to the current lens position, while the scanning operation is conducted at each lens position. Incidentally, in the case where the focus information is not obtained by the AF module even when the focus lens FL is moved to reach one of the ends, the scanning operation is again conducted along the direction toward the other end.

In the low-contrast scanning operation, when the focus information is obtained by the scanning operation at a certain lens position, the low-contrast scanning operation is finished, and the control proceeds to step SP29.

In step SP29, the lens focusing position determining operation is carried out by the phase difference AF control section 121, based on the focus information obtained.

Subsequently, in step SP30, the focus lens FL is driven to the lens focusing position thus determined.

As has been above-mentioned, in the image pickup apparatus 1A, the lens focusing position is estimated by use of the shooting distance, and the driving direction in which to move the focus lens FL in the low-contrast scanning operation is decided. This ensures that the focus lens FL can be driven in the direction in which the lens focusing position will be found at a higher possibility. Therefore, it is possible to shorten the time required for determination of the lens position at which the focus information can be obtained, and, therefore, to enhance the speed of the AF operation.

### 2. Second Embodiment

Now, a second embodiment of the present invention will be described.

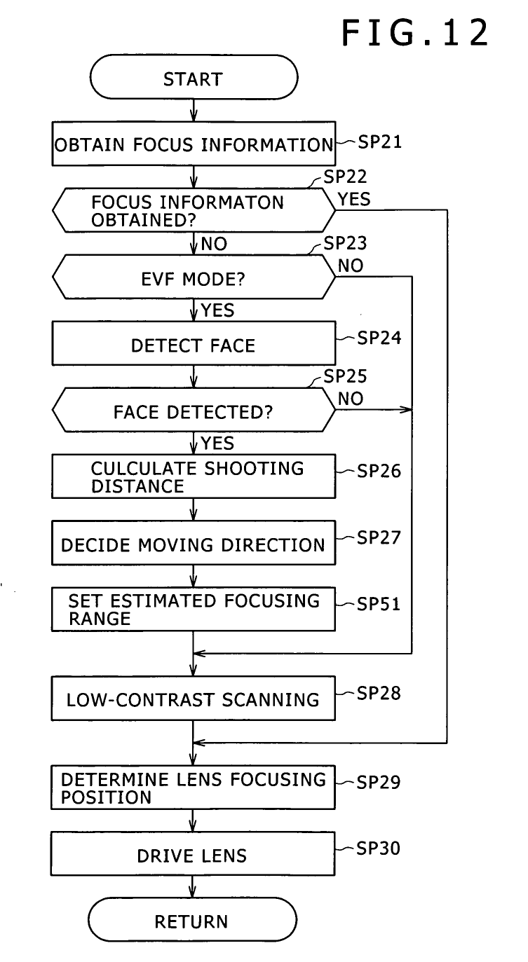

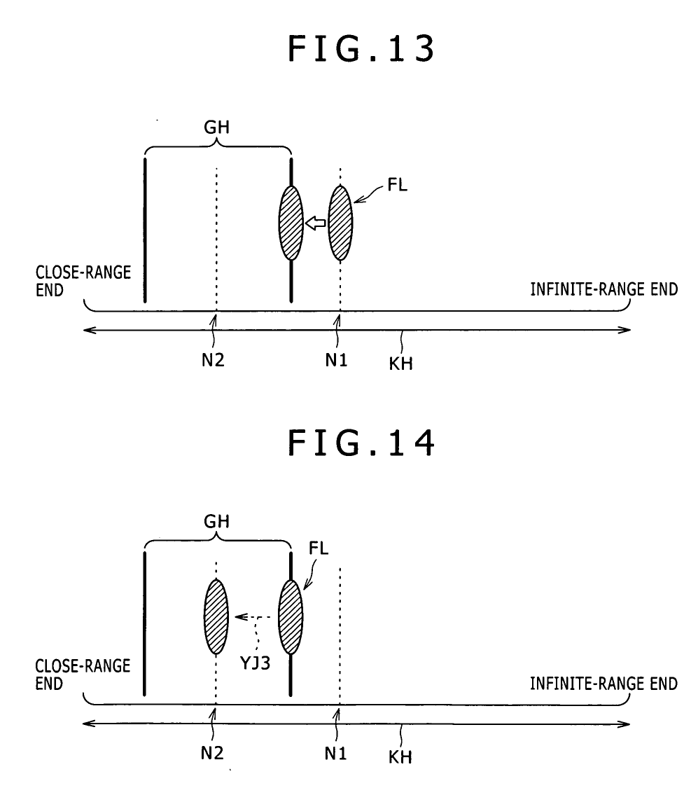

In an image pickup apparatus 1B according to the second embodiment, a driving range for the focus lens FL in which the scanning operation is to be conducted in the low-contrast scanning operation is decided in the control information obtaining section 125, and the driving range is transmitted to the drive control section 122 as drive information. FIG. 12 is a flow chart for the phase difference AF in the image pickup apparatus 1B. FIGS. 13 to 17 illustrate manners in which the focus lens FL is driven.

Incidentally, the image pickup apparatus 1B has substantially the same configuration and functions as those of the image pickup apparatus 1A according to the first embodiment (see FIGS. 1 to 6), except that an existence range GH of the lens focusing position is estimated, before deciding the range in which to carry out the scanning operation. Therefore, the parts provided in common to the both embodiments are denoted by the same reference symbols, and descriptions of them are omitted.

As above-mentioned, in the control information obtaining section 125 of the image pickup apparatus 1B, a lens focusing position existence range (referred to also as “estimated focusing range”) GH is determined by use of the shooting range (distance information), and the scanning operation is carried out in the estimated focusing range GH. In other words, in the image pickup apparatus 1B, the estimated focusing range GH is determined, and the range in which to carry out the scanning operation is set to the estimated focusing range GH.

As shown in FIG. 12, in step SP21 to step SP27 of the image pickup apparatus 1B, the same processings as in steps SP21 to SP27 (see FIG. 8) of the image pickup apparatus 1A are carried out. In brief, when the face region is detected from the auxiliary image in the EVF mode (step SP24), the shooting distance is calculated based on the result of face detection (step SP26). Then, the lens focusing position is estimated by use of the shooting distance, and the moving direction for the focus lens FL is decided based on the estimated lens position and the current lens position (step SP27).

In the subsequent step SP51, the estimated focusing range is set based on the estimated lens position.

Specifically, as shown in FIG. 13, with the estimated lens position “N2” as a reference, a range extended from the estimated lens position “N2” respectively toward the close-range end side and the infinite-range end side is set as the estimated focusing range GH. The width of extension is decided taking into account the accuracy in estimation of the estimated lens position, etc.

Then, in the case where the low-contrast scanning operation (step SP28) is carried out following to step SP51, the scanning operation is conducted in the estimated focusing range GH.

Specifically, in the case where the estimated focusing range GH exists on the close-range end side in relation to the current lens position “N1” as shown in FIG. 13, the image pickup apparatus 1B drives the focus lens FL to move at a high velocity from the current lens position “N1” to a position in proximity (on the current position side) to the estimated focusing range GH. During this movement, the scanning operation is not carried out. Subsequently, when the focus lens FL has reached the estimated focusing range GH (see FIG. 14), the image pickup apparatus 1B drives the focus lens FL to move at a comparatively low velocity toward the close-range end side as indicated by arrow YJ3 while performing the scanning operation.

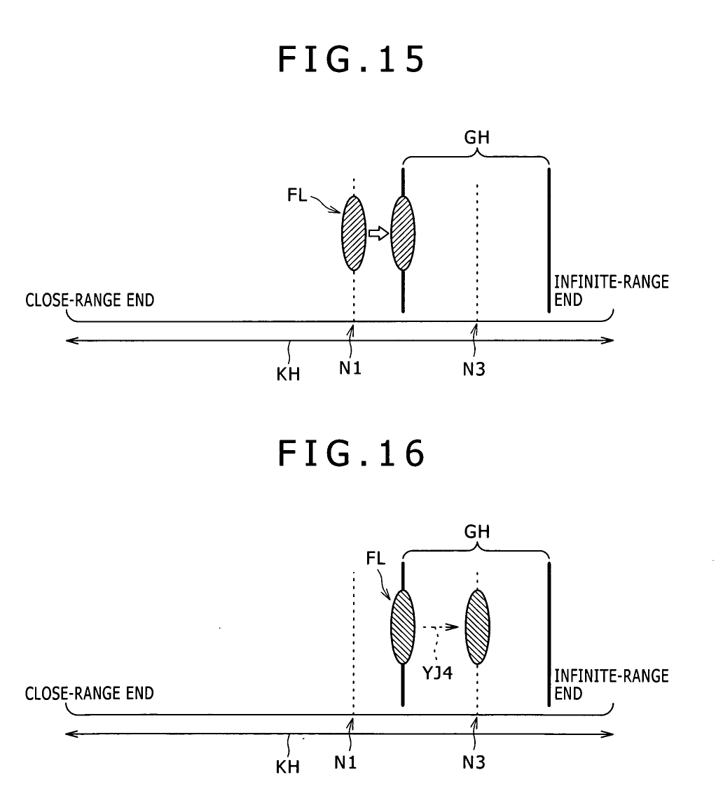

On the other hand, in the case where the estimated lens position “N3” exists on the infinite-range end side in relation to the current lens position “N1” as shown in FIG. 15, the estimated focusing range GH is set nearer to the infinite-range end. Then, if the estimated focusing range GH set with the estimated lens position “N3” as a reference is present on the infinite-range end side in relation to the current lens position “N1,” the image pickup apparatus 1B drives the focus lens FL to move at a high velocity from the current lens position “N1” to a position in proximity (on the current position side) to the estimated focusing range GH. During this movement, the scanning operation is not performed. Subsequently, when the focus lens FL has reached the estimated focusing range GH (see FIG. 16), the image pickup apparatus 1B drives the focus lens FL to move at a comparatively low velocity toward the infinite-range end side as indicated by arrow YJ4 while performing the scanning operation.

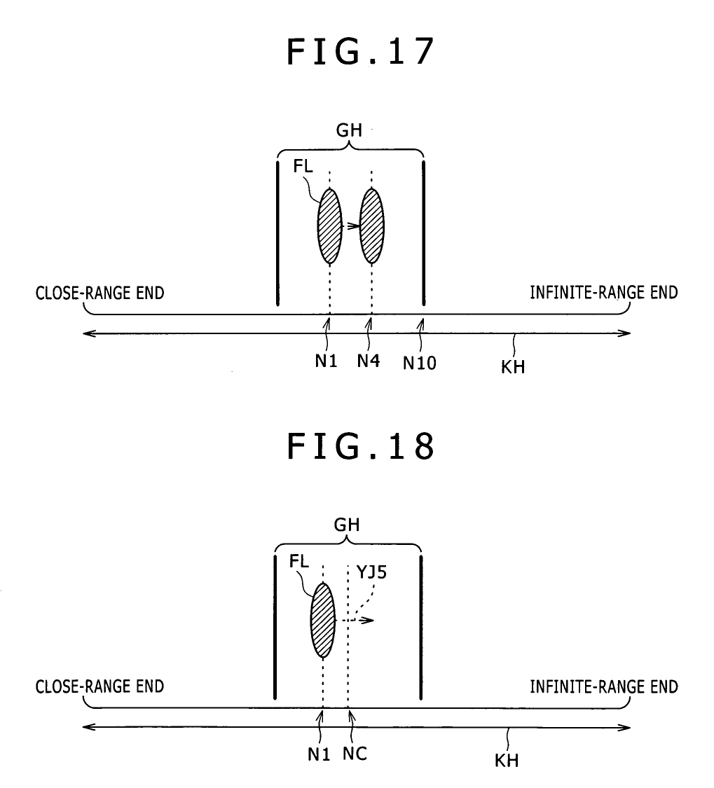

Further, in the case where the estimated lens position “N4” exists comparatively near the current lens position “N1” as shown in FIG. 17, the current lens position “N1” is included within the estimated focusing range GH set with the estimated lens position “N4” as a reference. In this case, the image pickup apparatus 1B drives the focus lens FL at a low velocity in the direction of the estimated lens position “N4” (in FIG. 17, toward the infinite-range end side) while performing the scanning direction. In the case where the focus information is not obtained even when the focus lens FL is moved to reach a boundary position “N10” of the estimated focusing range GH, the image pickup apparatus 1B turns back the focus lens FL at the boundary position “N10” and drives the focus lens FL to move at a low velocity in the opposite (reverse) direction (in FIG. 17, toward the close-range end side).

Thus, in the case where the low-contrast scanning operation is conducted following to step SP51, the scanning operation is carried out in the estimated focusing range GH. Incidentally, where the low-contrast scanning operation is performed without being preceded by the execution of step SP51, a normal low-contrast scanning operation is carried out in the drivable range KH.

In the low-contrast scanning operation, when the focus information is obtained by the scanning operation at a certain lens position, the low-contrast scanning operation is finished, and the control proceeds to step SP29.

In step SP29, the lens focusing position determining operation is performed in the phase difference AF control section 121, based on the focus information obtained.

Subsequently, in step SP30, the focus lens FL is driven to the lens focusing position thus determined.

Thus, in the image pickup apparatus 1B, the range in which to carry out the scanning operation is limited to the estimated focusing range GH. Therefore, needless scanning operations can be omitted, so that it is possible to shorten the time required for determination of the lens position at which the focus information can be obtained.

Besides, in the image pickup apparatus 1B, in the case where the focus lens FL is located outside of the estimated focusing range GH, the focus lens FL is moved at a high velocity to the estimated focusing range GH. This promises a further shortening of the time required for the low-contrast scanning operation.

### 3. Modification

While some embodiments of the present invention have been described above, the invention is not limited to the contents of the above description.

For example, while the shooting distance is calculated and used to obtain the estimated lens position and the estimated focusing range GH is determined based on the estimated lens position in the second embodiment above, the present invention is not limited by this configuration.

Specifically, the shooting distance thus calculated has an error; in view of this, therefore, the lens focusing position existence range (estimated focusing range) GH may be directly calculated on the basis of the shooting distance.

Incidentally, where the estimated focusing range GH is calculated directly, the driving direction for the focus lens FL in the case where the current lens position is included within the estimated focusing range GH is decided with the center of the estimated focusing range GH as a reference. FIG. 18 illustrates the manner in which the focus lens is driven.

Specifically, the focus lens FL is driven to move along the direction from the current lens position toward the center of the estimated focusing range GH. For instance, in FIG. 18, the current position of the focus lens FL is located on the close-range end side in relation to the center NC of the estimated focusing range GH, and, therefore, the focus lens is driven to move toward the infinite-range end side as indicated by arrow YJ5.

In addition, while the face region is detected from the shot image obtained by the sub image sensor 7 in the embodiments above, the present invention is not limited by this configuration.

Specifically, in the case where the shot images for live view display are obtained by the main image sensor 5, the face region may be detected from the shot image obtained by the main image sensor 5 and the result of face detection may be used for the low-contrast scanning operation.

The present application contains subject matter related to that disclosed in Japanese Priority Patent Application JP 2008-147668 filed in the Japan Patent Office on Jun. 5, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image pickup apparatus comprising:
an image sensor operative to obtain a shot image related to a subject image;
means for detecting a face region of a subject from said shot image;
means for calculating information on distance to said subject according to a size of said face region;
means for obtaining focus information according to a focusing condition obtained by use of a focusing lens;
operation control means for effecting a determining operation when it is difficult to obtain said focus information by said obtaining means, said determining operation being to move said focusing lens and to determine a lens position at which said focus information can be obtained; and
means for deciding a moving direction for said focusing lens in said determining operation, based on said distance information.

2. The image pickup apparatus according to claim 1, further comprising:
means for detecting a current lens position of said focusing lens;
wherein said deciding means estimates a lens focusing position at which a focused condition can be realized based on said distance information, and decides said moving direction according to positional relationship between said estimated lens focusing position and said current lens position.

3. The image pickup apparatus according to claim 2 further comprising;
means for setting a moving range for said focusing lens in said determining operation, based on said distance information; wherein
said operation control means moves said focusing lens at a first velocity when said current position is included in said moving range, and
moves said focusing lens at a second velocity higher than said first velocity when said current lens position is not included in said moving range.

4. The image pickup apparatus according to claim 3, wherein said operation control means moves said focusing lens at said second velocity into said moving range when said current lens position is not included in said moving range.

5. The image pickup apparatus according to claim 4, wherein said operation control means does not perform said determining operation when said current lens position is not included in said moving range.

6. A method of controlling an image pickup apparatus, comprising the steps of:
(a) obtaining a shot image related to a subject image;
(b) detecting a face region of a subject from said shot image;
(c) calculating information on the distance to said subject according to a size of said face region;
(d) obtaining focus information according to a focusing condition obtained by use of a focusing lens;
(e) effecting a determining operation when it is difficult to obtain said focus information in said step (d), said determining operation being to move said focusing lens and to determine a lens position at which said focus information can be obtained; and
(f) deciding a moving direction for said focusing lens in said determining operation, based on said distance information.
